(19) United States
(12) Patent Application Publication
(10) Pub. No.: US 2026/0151927 A1
(43) Pub. Date: Jun. 4, 2026

(54) DETERMINING A WEAR LEVEL OF A TREATMENT HEAD OF A PERSONAL CARE DEVICE

(71) Applicant: KONINKLIJKE PHILIPS N.V., EINDHOVEN (NL)

(72) Inventors: KLAUS SCHAEFERS, EINDHOVEN (NL); ADITHYA VIJAYKUMAR, EINDHOVEN (NL); JAN MARTIJN KRANSA, DEN BOSCH (NL)

(21) Appl. No.: 19/123,099

(22) PCT Filed: Oct. 17, 2023
(86) PCT No.: PCT/EP2023/078720

§ 371 Date: Apr. 22, 2025

(30) Foreign Application Priority Data
Oct. 26, 2022 (EP) 22203757.4

(51) Int. Cl. G06T 7/00; G06T 7/13; G16H 50/20

(52) U.S. Cl. CPC B26B 21/4087; A46B 15/001; A46B 2200/1066

(57) ABSTRACT

According to an aspect, there is provided a computer-implemented method (100) for determining the lifetime of a treatment head of a personal care device, the method comprising: receiving (102) a plurality of images of the treatment head, each of the plurality of images captured at a different time during a lifetime of the treatment head; determining (104), for each image in the plurality of images, a wear level indicative of a level of wear of the treatment head at the time that the image was captured; and determining (106), based on the plurality of wear levels, an estimated time at which the treatment head is to be replaced.

### FIELD OF THE INVENTION

The invention relates to personal care devices that include treatment heads and, more particularly, to determining how quickly a treatment head is wearing away with use.

### BACKGROUND OF THE INVENTION

Personal care devices are used by people to perform personal care activities, such as hair care activities (e.g., shaving or trimming), skin treatment activities (e.g., skin brushing) and oral care activities (e.g., toothbrushing). A different type of personal care device may be used for each personal care activity, and each personal care device may include a treatment portion, sometimes referred to as a treatment head. The treatment head of a personal care device is the part that performs the intended treatment (e.g., the cutting of the hair, the brushing of the skin or the brushing of the teeth). Over time, with use, part or parts of the treatment head may become worn (e.g., work down or worn away) and, as such, the treatment head may become less effective, and its ability to perform the intended treatment may reduce. The treatment head may therefore be replaceable, meaning that a user can replace just the treatment head part of the personal care device.

A treatment head may include a visual marker indicative of how worn the treatment head is, and this can aid a user in replacing the treatment head at an appropriate time. However, treatment head wear occurs at different rates for different users, depending on the frequency and nature of use, and the visual marker may therefore change very gradually over time. A user may find it difficult to notice changes in the visual marker over time and, therefore, may find it difficult to judge the best time to order a replacement treatment head so that it arrives at an appropriate time.

There is therefore a desire for a mechanism that is capable of quantifying the degree of wear of a treatment head such that an indication of the estimated remaining life of the treatment head can be provided to a user.

### SUMMARY OF THE INVENTION

The present invention provides a mechanism that enables a quantitative assessment of a treatment head to be made, so that the degree of wear of the treatment head can be estimated and communicated to a user of a personal care device with which the treatment head is to be used. In this way, a user who might not recognise changes in a visual marker of a treatment head can be informed of the degree of wear of the treatment head, such that a replacement treatment head can be ordered and installed before the worn treatment head becomes ineffective. The inventors of the present disclosure have recognised that, by using computer-vision based analysis techniques (e.g., image processing algorithms) applied to images of a treatment head, it is possible to determine a level of wear of the treatment head corresponding to each image, and to predict, based on how the level of wear has changed over time, an estimated remaining life of the treatment head, so that a replacement treatment head can be ordered in a timely manner.

According to a first specific aspect, there is provided a computer-implemented method for determining the lifetime of a treatment head of a personal care device, the method comprising receiving a plurality of images of the treatment head, each of the plurality of images captured at a different time during a lifetime of the treatment head; determining, for each image in the plurality of images, a wear level indicative of a level of wear of the treatment head at the time that the image was captured; and determining, based on the plurality of wear levels, an estimated time at which the treatment head is to be replaced.

By estimating the remaining life of the treatment head and, therefore, the time at which the treatment head is to be replaced, using the image processing techniques to assess images of the treatment head, the wear of the treatment head can be assessed in a more quantitative manner than would be the case if a user were to assess the treatment head manually, for example by judging the level of wear based on a visual indicator included the treatment head. In this way, the treatment head can be replaced at an appropriate time, before the level of wear of the treatment head becomes too great, leading to a reduced performance, which could lead to a bad experience for the user, or even result in an ineffective treatment when performing a personal care activity.

In some embodiments, the method may further comprise determining, based on the estimated time at which the treatment head is to be replaced, an indication time at which a recipient device is to be provided an indication that the treatment head should be replaced; and generating an instruction signal to be provided for delivery to the recipient device at the indication time.

Determining each wear level may comprise applying an edge detection algorithm to detect edges visible in a pattern displayed on the treatment head.

In other embodiments, determining each wear level may comprise providing each image of the plurality of images as an input to a predictive model trained to classify an image according to an estimated level of wear of a treatment head visible in the image.

Determining each wear level may, in some embodiments, comprise applying at least one of an object detection algorithm and an image segmentation algorithm to detect a region in each image of the plurality of images that is expected to contain a defined marker; and providing each image of the plurality of images as an input to a predictive model trained to detect the defined marker. The predictive model may generate a score indicative of the level of wear of the treatment head.

In other embodiments, determining the estimated time at which the treatment head is to be replaced may comprise fitting a function to the plurality of determined wear levels; and determining the estimated time at which the treatment head is to be replaced based on the fitted function.

Determining the estimated time at which the treatment head is to be replaced may comprise estimating, using a regression algorithm applied to the plurality of determined wear levels, a function describing how the level of wear of the treatment head varies over time; and determining the estimated time at which the treatment head is to be replaced based on the estimated function.

In some embodiments, the method may further comprise generating, for delivery to a recipient device, a notification to prompt a user of the personal care device to capture a further image showing the treatment head.

The method may further comprise generating, for presentation to a user of the personal care device via a recipient device, instructions to prompt the user to manipulate at least one an image capture device and the treatment head such that an image of the treatment head captured using the image capture device meets a set of defined criteria.

In some embodiments, the method may comprise determining, based on the estimated time at which the treatment head is to be replaced, that the time remaining of the lifetime of the treatment head is less than a defined duration; and generating, for delivery to a recipient device, a notification to prompt a user of the personal care device to purchase a replacement treatment head.

In some embodiments, the method may further comprise receiving device data indicative of how the personal care device has been used during previous treatment sessions; and determining the estimated time at which the treatment head is to be replaced further based on the received data.

According to a second specific aspect, there is provided a computer program product comprising a non-transitory computer-readable medium, the computer-readable medium having computer-readable code embodied therein, the computer-readable code being configured such that, on execution by a suitable computer or processor, the computer or processor is caused to perform the method of any of the preceding claims.

According to a third specific aspect, there is provided an apparatus for determining the lifetime of a treatment head of a personal care device, the apparatus comprising a processor configured to perform steps of the methods disclosed herein.

According to a fourth specific aspect, there is provided a system comprising a personal care device having a body portion and a replaceable treatment head detachably coupled to the body portion; and an apparatus as disclosed herein.

In some embodiments, the system may further comprise an image capture device for capturing the plurality of images.

These and other aspects will be apparent from and elucidated with reference to the embodiment(s) described hereinafter.

### BRIEF DESCRIPTION OF THE DRAWINGS

Exemplary embodiments will now be described, by way of example only, with reference to the following drawings, in which:

FIG. 1 is a flowchart of an example of a method for determining the lifetime of a treatment head of a personal care device;

FIG. 2 is a set of images showing an example of an edge detection technique;

FIG. 3 is a graph showing an example of an estimated time at which a treatment head is to be replaced;

FIG. 4 is a flowchart of a further example of a method for determining the lifetime of a treatment head of a personal care device;

FIG. 5 is a schematic illustration of an example of a processor in communication with a computer-readable medium;

FIG. 6 is a schematic illustration of an example of an apparatus for determining the lifetime of a treatment head of a personal care device; and

FIG. 7 is a schematic illustration of a system for determining the lifetime of a treatment head of a personal care device.

FIG. 8 is a graph showing a confusion matrix of an example of the implementation of a predictive model in method according to the present invention.

### DETAILED DESCRIPTION OF THE EMBODIMENTS

Embodiments disclosed herein provide a mechanism by which a level of wear of a treatment head of a personal care device can be determined based on analysis of a plurality of images of the treatment head at various stages during its lifetime. As described below, various techniques may be used to analyse the images, and based on the analysis, it is possible to estimate when the treatment head should be replaced, to reduce the likelihood that a user of the treatment head suffers from ineffective treatment.

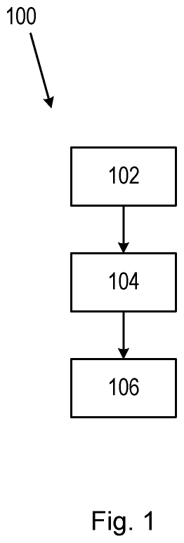

Referring to the drawings, FIG. 1 is a flowchart of an example of a method 100, such as a computer implemented method, for determining the lifetime of a treatment head of a personal care device. A personal care device may comprise a device or instrument used to perform a personal care activity, and may include, for example, a hair cutting device such as a hair trimmer or a shaving device, a skin treatment device such as a facial cleansing brush, a skin rejuvenation device or an intense pulsed light (IPL) device, an oral care device such as a power toothbrush or an air flossing device, or the like. Each personal care device may include a treatment head that performs the intended treatment to the subject during use. For example, the treatment head of a shaving device may comprise a cutting head or blade(s) that cut hair of the subject during use, and the treatment head of a power toothbrush may comprise a brush head attachment having bristles that clean the subject's teeth during use.

One or more parts of the treatment head of a personal care device may become worn over time, for example through repeated engagement with the subject (e.g., the subject's hair teeth) during use. For example, the blade(s) of a shaving device may become blunt, such that the hair cutting ability is less effective, and the bristles of a power toothbrush may become worn and misaligned, leading to less effective cleaning of the teeth. Each treatment head may have a lifetime which is considered to expire when the treatment head has become worn to such an extent that its ability to perform the intended treatment is significantly reduced.

The method 100 comprises, at step 102, receiving a plurality of images of the treatment head, each of the plurality of images captured at a different time during a lifetime of the treatment head. Each image may, for example, comprise a photograph of the treatment head, which may be captured using an image capture device such as a camera. For example, a user of the treatment head, or of a personal care device with which the treatment head is used, may take a photograph of the treatment head using the camera of a smart phone for example, and the image (e.g., the image data representing the image) may be received by a device (e.g., a processor or processors) performing the method 100. Each of the images of the plurality of images shows the treatment head at a different time during his lifetime. For example, a first image of the plurality of images may be captured on a first date after a first treatment session, and a second image of the plurality of images may be captured on a second date after a second treatment session, and so on.

It may be intended that each image of the treatment head shows a particular part of the treatment head from which a determination of a level of wear can be made. For example, it may be intended that each image of a treatment head of a shaving device should show the blades, while each image of a treatment head of a power toothbrush should show the bristles. As noted below, a mechanism may be provided to prompt a user to capture a photograph that better shows the relevant part of the treatment head, following an assessment of an image received at step 102.

A user may be prompted or requested to upload an image of the treatment head or to take a photograph of the treatment head showing the relevant part (e.g., the part of the treatment head from which a level of wear can be determined) of the treatment head in its current state. In some embodiments, the user may be guided through the image capture process with a series of instructions informing the user how to capture an appropriate image (e.g., with regard to viewing angle, resolution, zoom level, lighting conditions, and the like). In other embodiments, an augmented reality (AR) stencil or template may be provided to guide the user how to capture an appropriate image of the treatment head. In such examples, the guidance may be provided to the user via a display on a mobile device (e.g., via an application on the user's smart phone). The mobile device may provide an indication (e.g., visual or audible) notifying the user when the conditions (e.g., viewing angle, lighting conditions and the like) are suitable for capturing an image of the treatment device from which a level of wear can be determined.

At step 104, the method 100 comprises determining, for each image in the plurality of images, a wear level indicative of a level of wear of the treatment head at the time that the image was captured. One or more computer-vision algorithms (e.g., image processing techniques) may be used for determining the wear level of the treatment head for each image. In examples disclosed herein, the wear level determination may be made using edge detection techniques, machine learning techniques, or object detection/segmentation techniques.

In a first example, determining (step 104) each wear level may comprise applying edge detection algorithm to detect edges visible in a pattern displayed on the treatment head. A treatment head may include a pattern, symbol or marking, the appearance of which changes over time, as the treatment head becomes more worn. In one example, a skin-engaging portion of a treatment head may include a pattern, such as a grid, which has been printed, painted or otherwise formed on the skin-engaging portion. The skin-engaging portion of a treatment head of a shaving device may, for example, comprise a blade or blades. As the treatment head (e.g., the skin-engaging portion of the treatment head) wears down with use, the pattern formed thereon may become less visible, or its appearance may change in some other way indicative of the level of wear. In another example, as the level of wear of the treatment head increases, a pattern formed beneath the skin-engaging portion may become more visible.

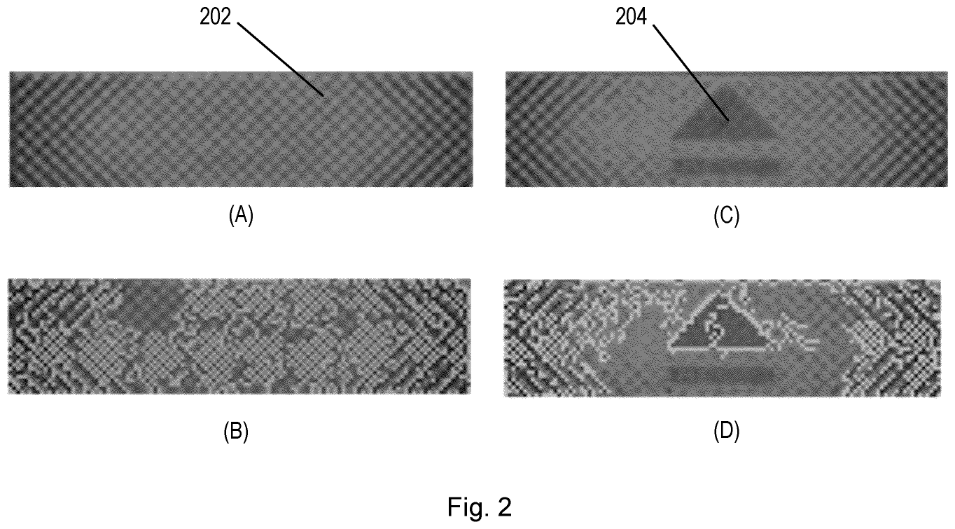

When the treatment head is new, the pattern may be complete and may be fully visible to an observer (e.g., the user). In an example, the pattern may comprise a grid (e.g., hatching) formed over at least some of the treatment head, and in a new, unused treatment head, the grid-like pattern may include a defined number (e.g., 500) of lines, or edges, that are detectable using an edge detection algorithm. FIG. 2 shows illustrations of an example of a pattern formed on a treatment head, such as a cutting portion of a shaving device. FIG. 2A shows an example of the treatment head when it is new, with a grid-like pattern 202 formed of a series of hatched diagonal lines fully visible across the surface of the treatment head. FIG. 2B shows an example of an image representing the edges detected in the image of FIG. 2A by an edge detection algorithm. As can be seen, a large proportion of the edges (e.g., lines) present in the grid-like pattern 202 are detected and can be counted. In this example, the edge detection algorithm has detected 430 edges, and this may be considered to relate to a new, or nearly new, treatment head.

FIG. 2C shows an example of the treatment head after a significant amount of use, such that part of the grid-like pattern 202 has been worn away. FIG. 2D shows an example of an image representing the edges detected in the image of FIG. 2C by the edge detection algorithm. In this case, 160 edges (e.g., lines) are detected, which is far fewer than in the case shown in FIG. 2B. In an example, a proportion of the number of lines or edges detected using the edge detection algorithm may be indicative of a level of wear of the treatment head. For example, if half the edges are detected compared to when the treatment head was new, then the treatment head may be considered to be 50% worn and/or 50% through its lifetime. An advantage of using an edge detection algorithm in this way is that no training of the algorithm is required.

In the example shown in FIGS. 2C and 2D, an image of a symbol 204 is also visible on the treatment head. The symbol 204 may be located (e.g., printed or painted) on a surface beneath the wearable part of the treatment head, such that as the treatment head becomes worn, and the grid-like pattern 202 wears away, the symbol 204 becomes more visible. The gradual appearance of the symbol 204 may provide a visual indication to a user that the treatment head is becoming worn and is approaching the end of its life. In some examples, an object detection algorithm, may be used to look for and detect the symbol 204 in the received image of the treatment head. In such examples, a level of confidence (e.g., a confidence score) with which the object detection algorithm is able to detect the symbol 204 may be indicative of the level of wear of the treatment head. For example, if the object detection algorithm detects the symbol 204 with only 10% confidence (e.g., because the grid-like pattern 202 covers most of the symbol), then it may be determined that the treatment head is 10% worn. However, if the object detection algorithm detects the symbol 204 with 90% confidence, then this is likely to be because most of the grid-like pattern 202 has been worn away and, therefore, it may be determined that the treatment head is 90% worn.

In some examples, the object detection algorithm—which may comprise a “you only look once” (YOLO) algorithm—may, for each image, determine a score (e.g., a probability score) for each of a plurality of classes. For example, the algorithm may consider 10, 100 or some other number of classes, and for each class, the algorithm may determine a score for the image. In an example, the algorithm may determine a score for each of 10 classes. The score for each class may be considered to be a likelihood or probability that the image belongs to that class, and each class may correspond to a different level of wear. The algorithm may determine that the image belongs to the class corresponding to the highest determined score. Accordingly, the treatment head shown in that image may be considered to have a level of wear corresponding to the level of wear associated with the highest scoring class.

In a second example, determining (step 104) each wear level may comprise providing each image of the plurality of images as an input to a predictive model trained to classify an image according to an estimated level of wear of a treatment head visible in the image. Many different types of predictive model or algorithm may be used including, for example, an artificial neural network (e.g., a deep learning algorithm such as a convolutional neural network). The predictive model may be trained using training data comprising images of treatment head at different levels of wear. In some examples, the predictive model may focus on texture present in the image, for example in the case where the treatment head comprises a cutting blade of a shaving device. A new cutting blade may have rough surfaces, while a used cutting blade may have much smoother surfaces. As shown in the examples of FIGS. 2C and 2D, one or more visual markers or symbols may become visible or become gradually as the blades wear away. In such examples, the predictive model may be trained to detect the visual marker or symbol, and to determine a level of wear based on how clearly the marker or symbol can be seen. In some examples, the defined marker may comprise a pattern, such as the grid-like pattern discussed herein. The predictive model may provide as an output a classification into one of a set of categories indicating the estimated remaining lifetime of the treatment head. For example, the predictive model may classify a treatment head as 0 to 10% worn or 80 to 90% worn.

In a third example, an object detection algorithm and/or an image segmentation algorithm may be used to determine a level of wear of a treatment head based on an image of the treatment head. In this example, determining (step 104) each wear level may comprise applying at least one of an object detection algorithm and an image segmentation algorithm to detect a region in each image of the plurality of images that is expected to contain a defined marker. As an example, the defined marker may comprise the symbol 204 shown in FIG. 2. An object detection algorithm or an image segmentation algorithm may be used to analyse the image of the treatment head, and determine whether or not the marker (e.g., the symbol 204) is present in the image. The object detection algorithm or the image segmentation algorithm may be trained using a set of training images which have been annotated by drawing bounding boxes around the marker/symbol to be identified or indicating areas in the image that correspond to the marker/symbol. A predictive model may also be used, which has been trained using YOLO (i.e., you only look once) and/or COCO (i.e., common objects in context) datasets, to determine whether the symbol is present in the image. Thus, each image of the plurality of images may be provided as an input to a predictive model trained to detect of the defined marker. If it is determined that the symbol is present, then it may be determined that the treatment head has been worn down. Generally, the predictive model may generate a score indicative of the level of wear of the treatment head. The score generated by the predictive model may comprise a probability score or a confidence score, and/or may be based on a prediction probability, a conditional probability, a confidence in the prediction, an objectiveness of the detection, or a combination of these.

Referring again to FIG. 1, the method 100 comprises, at step 106, determining, based on the plurality of wear levels, an estimated time at which the treatment head is to be replaced. Once the method 100 has determined (e.g., estimated) the level of wear of the treatment head in each image (i.e., an amount that the treatment head has been worn at various times corresponding to the times at which the images were captured), an estimation can be made regarding how this much of the treatment head useful life remains. In one example, determining the estimated time at which the treatment head is to be replaced may comprise fitting a function to the plurality of determined wear levels, and determining an estimated time at which the treatment head is to be replaced based on the fitted function. The determined wear levels may be time-stamped wear levels, as they are indicative of a level of wear at a particular time.

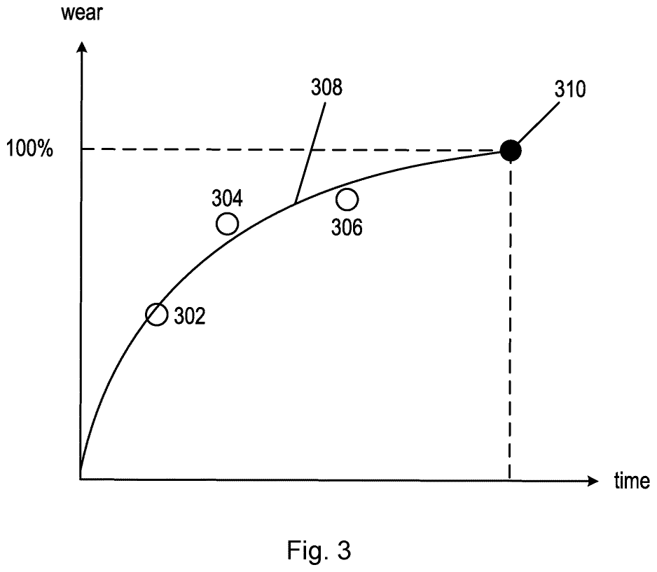

FIG. 3 is a graph showing an example of the determined level of wear of a treatment head plotted against time for each of three images captured on three different dates over the lifetime of a treatment head. In this example, point 302 represents a level of wear of the treatment head determined from an image captured at a first date, after a first period of use, point 304 represents a level of wear of the treatment head determined from an image captured at a second date, after a second period of use, and point 306 represents a level of wear of the treatment head determined from an image captured at a third date, after a third period of time. With the plurality of wear levels plotted in the graph, a function is fitted to the data, as indicated by line 308. It will be apparent that a better-fitting function may be achieved if the more data points are included in the graph, the better the fit of the function will be. Based on the fitted function, it is possible to determine a time/date 310 in the future at which the level of wear of the treatment head will reach 100%, or will reach a defined level of wear considered to be representative of the end of the treatment head's useful life. The determined end date 310 of the treatment head's life is the date at which the treatment head is likely to be fully worn, based on the past usage of the treatment head. It may be recommended, therefore, that the treatment had be replaced on the determined end date.

In some embodiments, determining the (step 106) the estimated time at which the treatment head is to be replaced may comprise estimating, using a regression algorithm applied to the plurality of determined wear levels, a function describing how the level of wear of the treatment head varies over time. In some examples, multiple algorithms may be used including, for example, simple linear models, such as linear regression models, non-linear models, support vector machines (SVM), artificial neural networks, autoregressive integrated moving average (ARIMA) models, or the like. The estimated time at which the treatment head is to be replaced may be determined based on the estimated function.

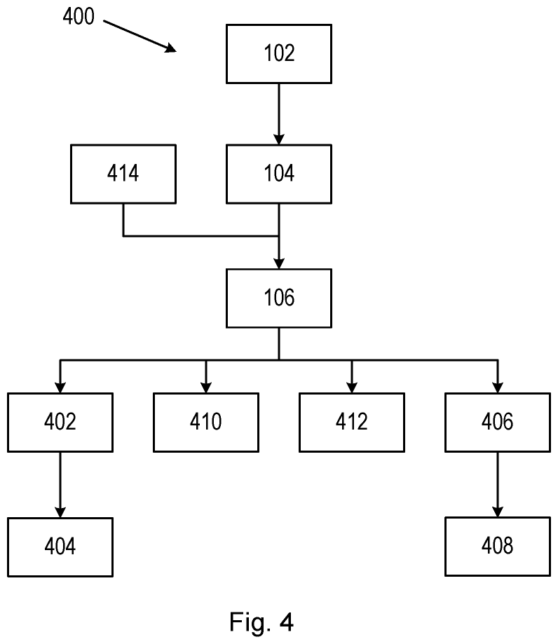

The embodiments disclosed above enable an estimation to be made of the likely date on which the treatment head will reach the end of its useful life. However, it may be even more helpful to be able to give a user of the treatment head prior notice that the end-of-life date of the treatment head is approaching, so that arrangements can be made to replace the treatment head in a timely manner. For example, a user may wish to purchase a replacement treatment head one or two weeks before the estimated end-of-life date to ensure that it arrives in time. Embodiments described below with reference to FIG. 4 provide these additional benefits.

FIG. 4 is a flowchart of a further example of a method 400 (e.g., a computer implemented method) for determining the lifetime of a treatment head of a personal care device. The method 400 may include steps of the method 100 discussed above. In some embodiments, the method 400 may further comprise, at step 402, determining, based on the estimated time at which the treatment head is to be replaced, an indication time at which a recipient device is to be provided an indication that the treatment head should be replaced. The indication time may be determined such that a recipient (e.g., a user of the recipient device) is provided with ample notice to replace the treatment head before or at the estimated time at which the treatment head is to be replaced. For example, the indication time may be determined based on an expected delivery duration, should the user need to order a replacement treatment head.

At step 404, the method 400 may further comprise generating an instruction signal to be provided for delivery to the recipient device at the indication time. The instruction signal may, for example comprise a signal to instruct a device (e.g., the personal care device, a computing device, a smart phone, a tablet computer, a wearable device, an interactive mirror, or the like) to display a message or notification informing a user of the device that the treatment head should be replaced.

In some embodiments, a user of a personal care device to which the treatment head is attached may be offered the opportunity to purchase a replacement tree head at an appropriate time, based on the determined estimate of the end-of-life date of the treatment head. For example, the method 400 may further comprise, at step 406, determining, based on the estimated time at which the treatment head is to be replaced, that the time remaining of the lifetime of the treatment head is less than a defined duration. The defined duration may, for example, comprise one week, 2 weeks, 1 month, or the like, and may be selected depending on the nature of the personal care device and/or the treatment head, and/or depending on the manner in which the personal care device has been used. At step 408, the method 400 may further comprise generating, for delivery to a recipient device, a notification to prompt a user of the personal care device to purchase a replacement treatment head. The notification may, for example, be delivered to the user's smart phone, via an application, enabling the user to a replacement treatment head so that it can be delivered to the user before the estimated time at which the treatment head is to be replaced.

The user of the personal care device may be prompted or requested to take a photograph and/or upload an image of the treatment head being used with the personal care device after each treatment session (e.g., after each use of the personal care device). In this way, regularly taken images of the treatment head may be used to determine an accurate estimation of the end-of-life date of the treatment head. The method 400 may, in some embodiments, comprise, at step 410, generating, for delivery to a recipient device, a notification to prompt a user of the personal care device to capture a further image showing the treatment head. For example, a message may be delivered to a smart phone of the user suggesting that the user takes a photograph of the treatment head after use, to be uploaded for level of wear analysis.

In some cases, an image of the treatment head received at step 102 may be considered to be too poor quality for an accurate assessment of its level of wear to be made. For example, the image of the treatment head may have been captured in sub-optimal lighting conditions, or from an angle that makes it difficult to analyse using an edge detection algorithm. In such examples, the user may be prompted or requested to capture and upload a new image of higher quality. Thus, the method 400 may further comprise, at step 412, generating, for presentation to a user of the personal care device via a recipient device, instructions to prompt the user to manipulate at least one an image capture device and the treatment head such that an image of the treatment head captured using the image capture device meets a set of defined criteria. The instructions may, for example, comprise textual and/or audible instructions directing the user to move a camera (e.g., a camera of a smart phone) and/or the treatment head into such a position that an image can be captured that meets the set of defined criteria. The defined criteria may include criteria relating to lighting conditions, orientation of the treatment head and/or the camera, image resolution, or the like.

According to the method 100, 400, it is possible to determine the estimated time at which the treatment head is to be replaced based on just a plurality of photos of the treatment head. However, in some embodiments, additional information may be available which can be used in addition to the images in order to determine the estimated end-of-life date of the treatment head. Thus, the method 400 may, in some embodiments, further comprise, at step 414, receiving device data indicative of how the personal care device has been used during previous treatment sessions. For example, data or information indicative of how often the personal care device has been used, and the duration of each usage may be provided and/or data from one or more sensors located in, on or around the personal care device, or otherwise associated with the personal care device. In some examples, data from an inertial measurement unit (IMU), a pressure sensor, a motor force sensor and/or an optical sensor may be used, for example to determine an intensity of a personal care activity, and data from one or more of the sensors may be used in determining the estimate. The data may be received by a wired or wireless connection. Thus, determining (step 106) the estimated time at which the treatment head is to be replaced may be further based on the received data. In an example, if the received device data indicates that the personal care device is used to vigorously during each usage, then the treatment head may become worn more quickly than if the personal care device is used gently, and with little force.

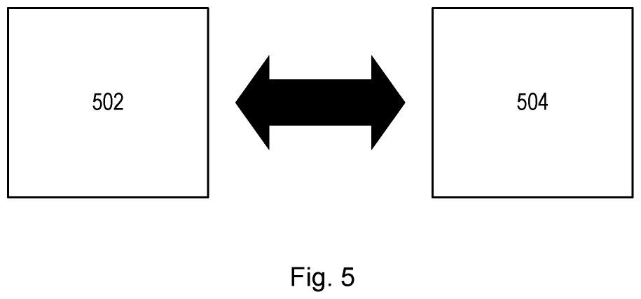

The present invention also provides a computer program product. FIG. 5 is a schematic illustration of an example of a processor 502 in communication with a computer-readable medium 504. According to embodiments, a computer program product comprising a non-transitory computer-readable medium 504, the computer-readable medium having computer-readable code embodied therein, the computer-readable code being configured such that, on execution by a suitable computer or processor 502, the computer or processor is caused to perform steps of the methods 100, 400 disclosed herein. Thus, steps of the methods 100, 400 may be performed using one or more processors contained in one or more computing devices and/or computing environments such as servers, for example located in a cloud computing environment.

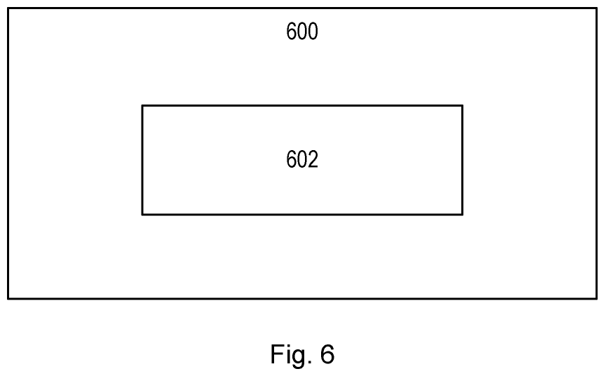

The present invention also provides an apparatus. FIG. 6 is a schematic illustration of an example of an apparatus 600 for determining the lifetime of a treatment head of a personal care device. The apparatus comprises a processor 602 (e.g., the processor 502) configured to perform steps of the methods 100, 400 disclosed herein. The apparatus 600 may, for example, comprise the personal care device with which the treatment head is used, a computing device such as a smart phone, a wearable device, an interactive mirror, or the like. In some embodiments, the processor 602 is located within the apparatus 600. In other embodiments, however, the processor performing the steps of the methods may be located remote from the apparatus 600 and/or from the personal care device.

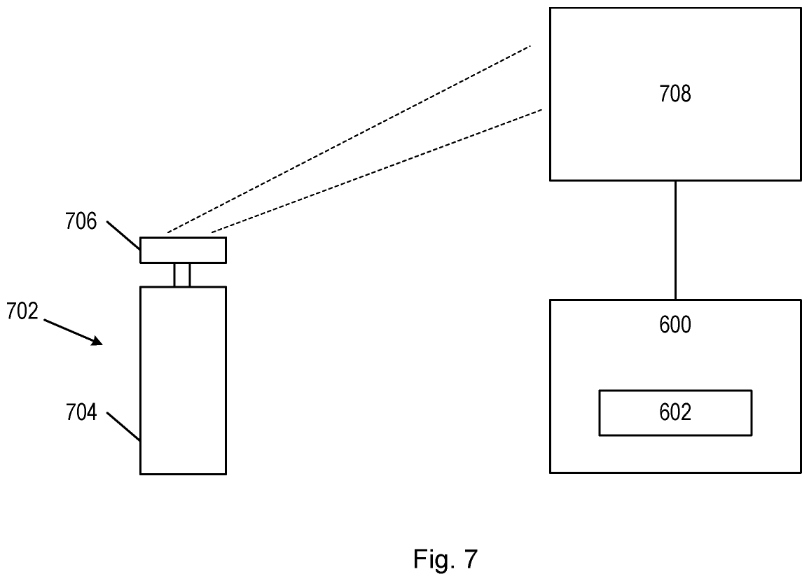

The present invention also provides a system. FIG. 7 is a schematic illustration of an example of a system 700 for determining the lifetime of a treatment head of a personal care device. The system 700 comprises a personal care device 702, having a body portion 704 and a replaceable treatment head 706 detachably coupled to the body portion. As discussed herein, the personal care device 702 may comprise a hair cutting device, a shaving device, an oral care device, a skin treatment device, or the like. The system 700 further comprises the apparatus 600. The apparatus 600 may be in operative communication with the personal care device 702, such that it can communicate with and receive data from the personal care device.

In some embodiments, the system 700 may further comprise an image capture device 708 for capturing the plurality of images. The image capture device 708 may comprise a camera in a mobile device such as a smart phone. In some embodiments, the image capture device 708 may form part of all be housed within the apparatus 600.

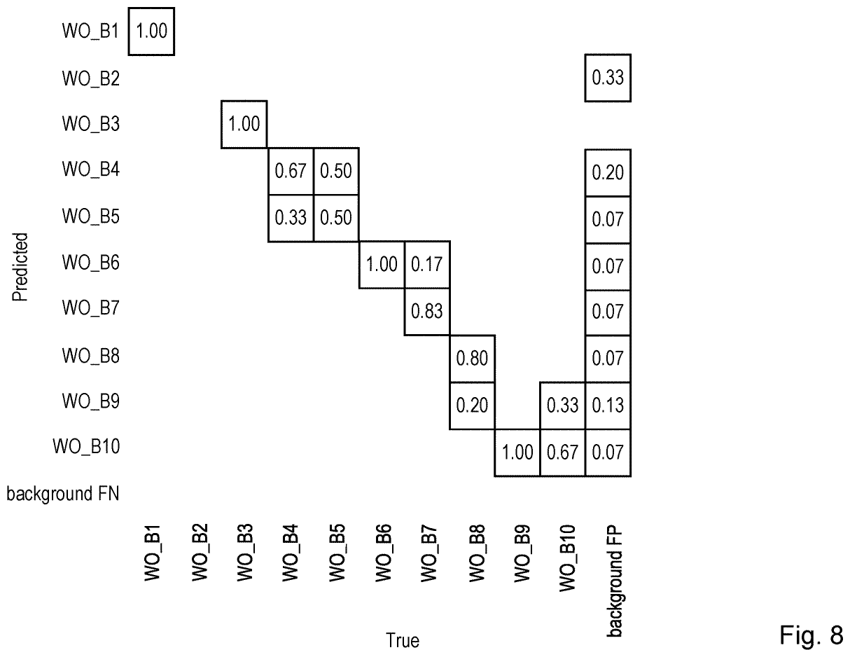

FIG. 8 is a chart showing an output of an example of a test of the use of a predictive model in the method 100 disclosed herein. The chart is a confusion matrix, which is a table showing the performance of the classification task (i.e., determining the level of wear of a treatment head, which in this case is a cutting element of a shaving device). In the x-axis of the confusion matrix, true labels (ground truth) are visualized and, in the Y axis, predicted labels are visualized. Inside each cell of the confusion matrix, a value from 0.0 to 1.0 indicates a confidence score of the predictive model. Labels “WO_B1” . . . “WO_B10” represent wear-off level classes of the treatment head (i.e., the cutting element), increasing incrementally from a non-worn out treatment head (“WO_B1”) to a completely worn out treatment head (“WO_B10”). In the confusion matrix, it is shown that some mispredictions have been made in the degree of +/−1 wear-off class (e.g., the square-cell region in “WO_B4” and “WO_B5”). A lack of values in the “background FN” row indicates that all of the treatment heads are detected and the values in the “background FP” column with low confidence scores indicate that some wrong bounding boxes have been detected by the predictive model, though these have been filtered out afterwards given the low confidence score values. The lack of any value in the “WO_B2” row or column is due to the fact that there was no “WO_B2” sample used in the test set. The test set contained a set of 36 images. The output shown in the confusion matrix indicates that the predictive model can accurately determine the level of wear of a treatment head from an image.

The processor 502, 602 can comprise one or more processors, processing units, multi-core processors or modules that are configured or programmed to control the apparatus 600 in the manner described herein. In particular implementations, the processor 502, 602 can comprise a plurality of software and/or hardware modules that are each configured to perform, or are for performing, individual or multiple steps of the method described herein.

The term “module”, as used herein is intended to include a hardware component, such as a processor or a component of a processor configured to perform a particular function, or a software component, such as a set of instruction data that has a particular function when executed by a processor.

It will be appreciated that the embodiments of the invention also apply to computer programs, particularly computer programs on or in a carrier, adapted to put the invention into practice. The program may be in the form of a source code, an object code, a code intermediate source and an object code such as in a partially compiled form, or in any other form suitable for use in the implementation of the method according to embodiments of the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g., Java interpreter instructions). Alternatively, one or more or all of the sub-routines may be stored in at least one external library file and linked with a main program either statically or dynamically, e.g., at run-time. The main program contains at least one call to at least one of the sub-routines. The sub-routines may also comprise function calls to each other. An embodiment relating to a computer program product comprises computer-executable instructions corresponding to each processing stage of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the principles and techniques described herein, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A computer-implemented method (100) for determining the lifetime of a treatment head of a personal care device, the method comprising:
receiving (102) a plurality of images of the treatment head, each of the plurality of images captured at a different time during a lifetime of the treatment head;
determining (104), for each image in the plurality of images, a wear level indicative of a level of wear of the treatment head at the time that the image was captured; and
determining (106), based on the plurality of wear levels, an estimated time at which the treatment head is to be replaced.

2. A computer-implemented method (100, 400) according to claim 1, further comprising:
determining (402), based on the estimated time at which the treatment head is to be replaced, an indication time at which a recipient device is to be provided an indication that the treatment head should be replaced; and
generating an instruction signal to be provided for delivery to the recipient device at the indication time.

3. A computer-implemented method (100, 400) according to claim 1, wherein determining each wear level comprises applying an edge detection algorithm to detect edges visible in a pattern displayed on the treatment head.

4. A computer-implemented method (100, 400) according to claim 1, wherein determining each wear level comprises providing each image of the plurality of images as an input to a predictive model trained to classify an image according to an estimated level of wear of a treatment head visible in the image.

5. A computer-implemented method (100, 400) according to claim 1, wherein determining each wear level comprises:
applying at least one of an object detection algorithm and an image segmentation algorithm to detect a region in each image of the plurality of images that is expected to contain a defined marker; and
providing each image of the plurality of images as an input to a predictive model trained to detect the defined marker;
wherein the predictive model generates a score indicative of the level of wear of the treatment head.

6. A computer-implemented method (100, 400) according to claim 1, wherein determining the estimated time at which the treatment head is to be replaced comprises:
fitting a function to the plurality of determined wear levels; and
determining the estimated time at which the treatment head is to be replaced based on the fitted function.

7. A computer-implemented method (100, 400) according to claim 1, wherein determining the estimated time at which the treatment head is to be replaced comprises:
estimating, using a regression algorithm applied to the plurality of determined wear levels, a function describing how the level of wear of the treatment head varies over time; and
determining the estimated time at which the treatment head is to be replaced based on the estimated function.

8. A computer-implemented method (100, 400) according to claim 1, further comprising:
generating (410), for delivery to a recipient device, a notification to prompt a user of the personal care device to capture a further image showing the treatment head.

9. A computer-implemented method (100, 400) according to claim 1, further comprising:
generating (412), for presentation to a user of the personal care device via a recipient device, instructions to prompt the user to manipulate at least one an image capture device and the treatment head such that an image of the treatment head captured using the image capture device meets a set of defined criteria.

10. A computer-implemented method (100, 400) according to claim 1, further comprising:
determining (406), based on the estimated time at which the treatment head is to be replaced, that the time remaining of the lifetime of the treatment head is less than a defined duration; and
generating (408), for delivery to a recipient device, a notification to prompt a user of the personal care device to purchase a replacement treatment head.

11. A computer-implemented method (100, 400) according to claim 1, further comprising:
receiving (414) device data indicative of how the personal care device has been used during previous treatment sessions; and
determining the estimated time at which the treatment head is to be replaced further based on the received data.

12. A computer program product comprising a non-transitory computer-readable medium (504), the computer-readable medium having computer-readable code embodied therein, the computer-readable code being configured such that, on execution by a suitable computer or processor, the computer or processor (502) is caused to perform the method of claim 1.

13. An apparatus (600) for determining the lifetime of a treatment head of a personal care device, the apparatus comprising:
a processor (602) configured to perform a method according to claim 1.

14. A system (700) comprising:
a personal care device (702) having a body portion (704) and a replaceable treatment head (706) detachably coupled to the body portion; and
an apparatus (600) according to claim 13.

15. A system (700) according to claim 14, further comprising:
an image capture device (708) for capturing the plurality of images.
